(19) United States
(12) Patent Application Publication
(10) Pub. No.: US 2014/0160289 A1
(43) Pub. Date: Jun. 12, 2014

(54) APPARATUS AND METHOD FOR PROVIDING INFORMATION OF BLIND SPOT

(71) Applicant: HYUNDAI MOTOR COMPANY, Seoul (KR)

(72) Inventors: Byoung Joon Lee, Hwaseong (KR); Ho Choul Jung, Suwon (KR); Jun Sik An, Seongnam (KR); Kap Je Sung, Hwaseong (KR)

(73) Assignee: HYUNDAI MOTOR COMPANY, Seoul (KR)

(21) Appl. No.: 13/858,530

(22) Filed: Apr. 8, 2013

(30) Foreign Application Priority Data
Dec. 12, 2012 (KR) 10-2012-0144896

(51) Int. Cl. G06K 9/00

(52) U.S. Cl. CPC G06K 9/00805
USPC 348/148

(57) ABSTRACT

Disclosed is an apparatus and method for providing information regarding a blind spot in a vehicle. The apparatus includes a view transforming area detector that is configured to detect a predefined side area and rear side area from a captured image input from a side imaging device. The imaging device is configured to capture the image including the blind spot of the vehicle. Additionally, the apparatus includes a view transformer that is configured to view transform an image of the side area and an image of the rear side area based on a pre-set view transformation parameter and generate view transformed images corresponding to the images of the side area and the rear side area.

### CROSS-REFERENCES TO RELATED APPLICATIONS

The priority of Korean patent application No. 10-2012-0144896 filed on Dec. 12, 2012, the disclosure of which is hereby incorporated in its entirety by reference, is claimed.

### BACKGROUND OF THE INVENTION

1. Field of the Invention

The present disclosure relates to an apparatus and a method for providing information regarding a blind spot in a vehicle, and more particularly, to technology which detects objects in a side area and a rear side area which are in a blind spot from a wide angle side image.

2. Description of the Related Art

In general, vehicle drivers check a rear side area of the vehicle through a side mirror. However, a blind spot, which may not be monitored using the side mirror, exists due to a limited available range of the side mirror. Therefore, drivers may be unable to check whether obstacles exists in the area of the blind spot.

Thus, to determine whether an obstacle or object is present in the blind spot, a sensor may be disposed in a vehicle. However, a separate sensor must be attached to the vehicle and a measurement error of the sensor occurs due to an effect of external environments and the characteristic of the sensor itself.

### SUMMARY

The present disclosure provides an apparatus and a method for providing information regarding a blind spot in a vehicle, which detect an object in a side area and a rear side area which are in a blind spot from an image of a wide angle side imaging device (e.g., a camera, a video camera, etc.).

Further, the present disclosure provides an apparatus and a method for providing information regarding a blind spot in a vehicle, which designate a side area and a rear side area in which change in a shape is minimized according to a location of an object in one side imaging device image and view transform images from two designated areas, thereby increasing object detection accuracy. Further, the present disclosure provides an apparatus and a method for providing information regarding a blind spot in a vehicle, which extract features from view transformed images in which images in a side area and a rear side area divided from an image of a wide angle side imaging device are view transformed and detect an object in a blind spot, thereby improving detection accuracy of object location.

According to an aspect of the present invention, an apparatus for providing information regarding a blind spot in a vehicle may include: a view transforming area detector executed by a controller and configured to detect a predefined side area and rear side area from a captured image input from a side imaging device configured to capture an image including the blind spot of the vehicle; and a view transformer configured to view transform an image of the side area and an image of the rear side area according to a pre-set view transformation parameter and generate view transformed images corresponding to the images of the side area and the rear side area.

The view transformer may include a table in which a value of the view transformation parameter has been previously defined and may perform view transformation on the image of the side area and the image of the rear side area based on the value of the view transformation parameter defined in the table.

The side imaging device may be a wide angle imaging device and the view transformer may view transform the captured image having a wide angle into an image having a narrower angle than a capturing angle.

The view transformer may include a first view transforming unit executed by the controller and configured to view transform the image of the side area according to a first view transformation parameter to generate a first view transformed image and a second view inverting unit executed by the controller and configured to view transform the image of the rear side area according to a second view transformation parameter to generate a second view transformed image.

The apparatus may further include a feature extractor executed by the controller and configured to extract features from the view transformed images; and a detector executed by the controller and configured to detect an object of the blind spot based on the features extracted from the view transformed images.

The detector may be configured to compare the features extracted from the view transformed images with pre-stored features of a vehicle and detect a vehicle disposed in the blind spot according to a comparison result. In particular, the features of the vehicle may include at least one selected from the group consisting of features of shapes of a front, a side, a bottom and a wheel of the vehicle and motion information of the vehicle.

According to an aspect of the present invention, a method for providing information of a blind spot in a vehicle may include: detecting, by a controller, a predefined side area and rear side area from a captured image input from a side imaging device configured to capture the image including the blind spot of the vehicle; and view transforming, by the controller, an image of the side area and an image of the rear side area according to a pre-set view transformation parameter and generating, by the controller, view transformed images corresponding to the images of the side area and the rear side area.

The generating view transformed images may include view transforming, by the controller, the images of the side area and the rear side area based on a value of the view transformation parameter defined in a table in which the value of the view transformation parameter has been previously defined.

The generating view transformed images may include first view transforming, by the controller, the image of the side area using a first view transformation parameter to generate a first view transformed image and second view transforming, by the controller, the image of the rear side area using a second view transformation parameter to generate a second view transformed image.

The method may further include extracting, by the controller, features from the view transformed images; and detecting, by the controller, an object of the blind spot based on the features extracted from the view transformed images.

The detecting an object of the blind spot may include comparing, by the controller, the features extracted from the view transformed images and pre-set features of a vehicle and detecting a vehicle in the blind spot based on a comparison result. In particular, the features of the vehicle may include at least one selected from the group consisting of features for shapes of a front, a side, a bottom and a wheel of the vehicle and motion information of the vehicle.

According to another exemplary embodiment, the controller may be configured to detect an object in a side area and a rear side area disposed in a blind spot from an image of a wide angle side imaging device, thereby improving object detection in the blind spot.

In particular, the present disclosure designates a side area and a rear side area in which shape change is minimized according to location of an object in one side image and view transform images of two designated areas, thereby increasing object detection accuracy. Further, the controller in present disclosure may be configured to extract features from the images into which the images of the side area and the rear side area divided from the image of the wide angle side imaging device is view transformed to detect the object in the blind spot, thereby improving detection accuracy of object location.

The systems and methods of the present invention have other features and advantages which will be apparent from or are set forth in more detail in the accompanying drawings, which are incorporated herein, and the following detailed description, which together serve to explain certain principles of the present invention.

### BRIEF DESCRIPTION OF THE DRAWINGS

FIG. 1 is an exemplary view explaining an operation of a vehicle having an apparatus for providing information of a blind spot according to an exemplary embodiment of the present disclosure.

FIG. 2 is an exemplary block diagram illustrating a configuration of an apparatus for providing information of a blind spot according to an exemplary embodiment of the present disclosure.

FIGS. 3 and 4 are exemplary views illustrating a view transformation operation of an apparatus for providing information of a blind spot according to an exemplary embodiment of the present disclosure

FIG. 5 is an exemplary view illustrating a feature extraction operation of an apparatus for providing information of a blind spot according to an exemplary embodiment of the present disclosure

FIG. 6 is an exemplary flowchart illustrating a method for providing information of a blind spot according to an exemplary embodiment of the present disclosure.

### DETAILED DESCRIPTION

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference will now be made in detail to various embodiments of the present invention(s), examples of which are illustrated in the accompanying drawings and described below. Like reference numerals in the drawings denote like elements. When it is determined that detailed description of a configuration or a function in the related disclosure interrupts understandings of embodiments in description of the embodiments of the invention, the detailed description will be omitted.

It should be understood that in a detail description below, as suffixes for configuration elements, ‘module’ and ‘unit’ are assigned or used together, for clarity, but there is no distinctive meaning or function between them per se.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

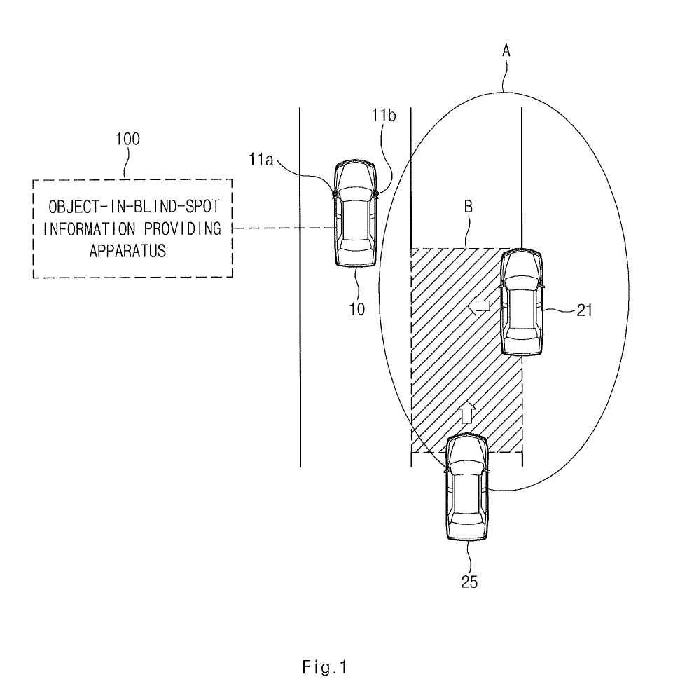

FIG. 1 is an exemplary view illustrating an operation of a vehicle having an apparatus for providing information regarding a blind spot according to the present disclosure. Referring to FIG. 1, a vehicle 10 may include a plurality of imaging devices 11a and 11b (e.g., cameras, video cameras, etc.) disposed on a side of the vehicle wherein the imaging devices may be configured to capture a side image when the vehicle 10 travels. Additionally, the imaging devices 11a and 11b disposed in the vehicle 10 may be imaging devices applied to an around view monitoring (AVM) system. The imaging devices 11a and 11b may be a wide angle imaging device. In particular, the wide angle imaging device may capture a distorted image having a wide angle of 190 degrees. Therefore, the image captured through the side imaging devices 11a and 11b of the vehicle 10 may include images of objects in a side area and a rear side area of the vehicle 10, such as, images of other vehicles 21 and 25.

Furthermore, when a side image is captured from the side imaging devices 11a and 11b of the vehicle 10, the captured side image may be transmitted to an apparatus 100 (e.g., a controller having a processor and a memory) configured to provide information regarding a blind spot in a vehicle.

In particular, to detect the objects in a blind spot B, the information providing apparatus 100 may be configured to divide the input captured image into a side area and a rear side area when the captured image is input from the side imaging devices 11a and 11b and detect objects from the images of the divided areas. Furthermore, locations and ranges of the side area and the rear side area may be previously set. The side area may be set in a substantially short distance from location of the vehicle and the rear area may be set in a substantially long distance from the location of the vehicle. Further, the side area and rear side area may include the blind spot B and may overlap each other.

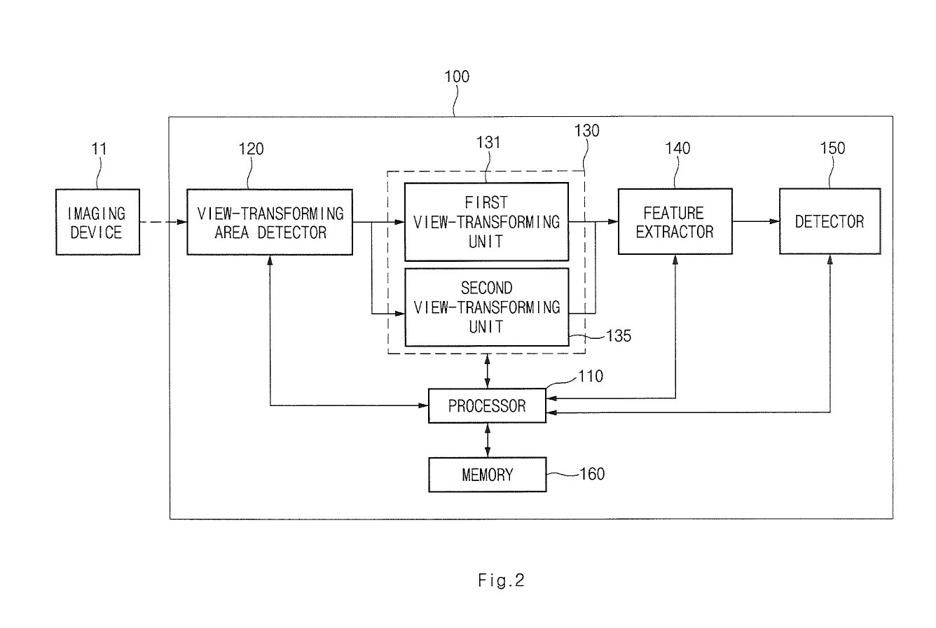

A configuration of the information providing apparatus will be described with reference to FIG. 2.

FIG. 2 is an exemplary block diagram illustrating a configuration of an information providing apparatus according to the present disclosure. Referring to FIG. 2, the information providing apparatus 100 may include a view transforming area detector 120, a view transformer 130, a feature extractor 140, and a detector 150, all executed by a processor on the controller.

The view transforming area detector 120 may be configured to receive a captured image from an imaging device disposed in the vehicle, in other words, a side imaging device and may be configured to detect a side area and a rear area in the received captured area. Furthermore, the side area and the rear side area may partially overlap each other and locations and dimensions of the side area and the rear side area may be set within a range in which shape change based on location of an object in the image is minimized. Further, the locations and dimensions of the side area and the rear side area may be variably set according to a pattern of the user.

The view transformer 130 may be configured to perform view transformation on images of the side area and the rear side area detected from the view transforming area detector 120 according to a pre-set view transformation parameter. The view transformer 130 may include a plurality of units executed by the controller. The plurality of units may include a first view transforming unit 131 and a second view transforming unit 135. The first view transforming unit 131 may be configured to perform view transformation on the image of the side area (hereinafter, referred to as a ‘first image’) and the second view transforming unit 135 may be configured to perform view transformation on the image of the rear side area (hereinafter, referred to as a ‘second image’).

The first view transforming unit 131 and second view transforming unit 135 may include respective tables in which a value of the view transformation parameter has been previously defined and may be configured to perform view transformation on the images of the side area and rear side area according to the values of the view transformation parameters defined in the respective tables.

As an example, the value of the view transformation parameter may be defined so that a wide angle image of 190 degrees is view transformed into a narrow angle image of 60 degrees. Therefore, the first view transforming unit 131 may be configured to perform view transformation on the first image based on a first pre-set view transformation parameter to generate a first view transformed image and the second view transforming unit 135 may be configured to perform view transformation on the second image based on a second pre-set view transformation parameter to generate a second view transformed image.

The first view transforming unit 131 and the second view transforming unit 135 may be configured to transmit the first view transformed image and the second view transformed image to the feature extractor 140, respectively. The feature extractor 140, executed by the processor on the controller, may be configured to analyze the input first and second view transformed images to extract features for a specific object, such as, a vehicle or a person.

As an example, the feature extractor 140 may be configured to extract at least one feature among a front end, a side shape, a bottom, an edge of a front side, and a wheel shape from the first view transformed image. At this time, the feature extractor 140 may be configured to substantially accurately extract a height and a full length of a vehicle in the first view transformed image and a vertical distance and a horizontal distance from the vehicle of the user to the vehicle in the first view transformed image through the features extracted from the first view transformed image.

Further, the feature extractor 140 may be configured to extract a feature for at least one selected from a group consisting of a front shape, a bottom, and a front edge of the vehicle from the second view transformed image. In particular, the feature extractor 140 may be configured to substantially accurately extract a height and a full length of a vehicle in the second view transformed image and a vertical distance and a horizontal distance from the vehicle of the user to the vehicle in the second view transformed image through the features extracted from the second view transformed image.

The feature extractor 140 may be configured to transmit the features extracted from the first view transformed image and the features extracted from the second view transformed image to the detector 150. The detector 150 executed by the processor on the controller, may be configured to analyze the features input from the feature extractor 140 and determine whether the features are features of a vehicle. When the controller determines that the detected features are substantially similar to the features of the vehicle, the detector 150 may be configured to detect the vehicle in the blind spot and recognize the position of the vehicle with improved accuracy.

When a person is detected in the blind spot instead of the vehicle, the detector 150 may be configured to analyze the features input from the feature extractor 140 and may determine whether the features are features of the person. When the controller determines that the detected features are substantially similar to the features of the person, the detector 150 may detect the person positioned in the blind spot.

Although not shown in FIG. 2, when an object such as a vehicle is detected in the side area and the rear side area of the vehicle, in particular, in the blind spot, the information providing apparatus may be configured to output an alarm sound through a buzzer and the like according to a detection result. Further, the information providing apparatus may be configured to display an image of the detected vehicle and the like through a monitor or a navigation screen disposed in the vehicle.

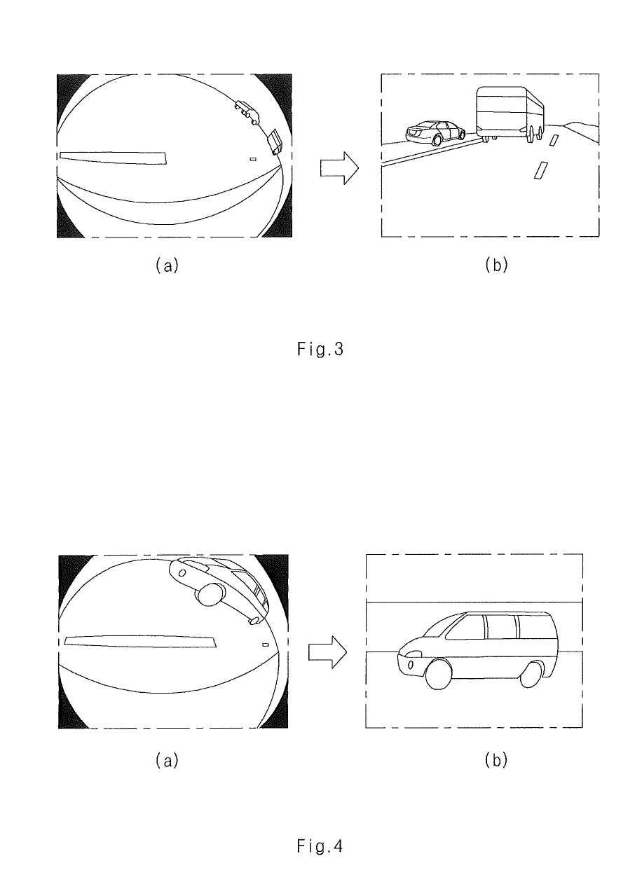

FIGS. 3 and 4 are exemplary views illustrating a view transformation operation of an information providing apparatus according to the present disclosure.

First, FIG. 3 illustrates a view transformation operation for a rear side area in a side image. Referring to FIG. 3, when an image of a side imaging device as illustrated in FIG. 3(a) is input, the information providing apparatus may be configured to detect a rear side area designated in the image of the side imaging device according to a pre-set value. The information providing apparatus may be configured to view transform the detected image of the rear side area and generate a view transformed image of the rear-side area as illustrated in FIG. 3(b).

In particular, the information providing apparatus may be configured to view transform the image of the rear side area detected from a wide angle image, such as, a wide angle image of 190 degrees illustrated in FIG. 3(a) into a narrow angle image, such as, a narrow angle image of 60 degrees. Therefore, a shape of an object in the view transformed image in the rear side area as illustrated in FIG. 3(b) may become sharper and a substantially accurate location of the object may be detected from the view transformed image of the rear side area.

FIG. 4 illustrates an exemplary view transformation operation of a side area in an image of a side imaging device. Referring to FIG. 4, when an image of a side imaging device as illustrated in FIG. 4(a) is input, the information providing apparatus may be configured to detect a side area designated in the image of the side imaging device according to a pre-set value. The information providing apparatus may be configured to view transform the detected image of the side area and generate a view transformed image of the side area as illustrated in FIG. 4(b). In particular, the information providing apparatus may be configured to view transform the image of the side area detected from a wide angle image, such as, a wide angle image of 190 degrees illustrated in FIG. 4(a) into a narrow angle image, such as, a narrow angle image of 60 degrees. Therefore, a shape of an object in the view transformed image in the side area as illustrated in FIG. 4(b) may become sharper and a substantially accurate location of the object may be detected from the view transformed image of the side area.

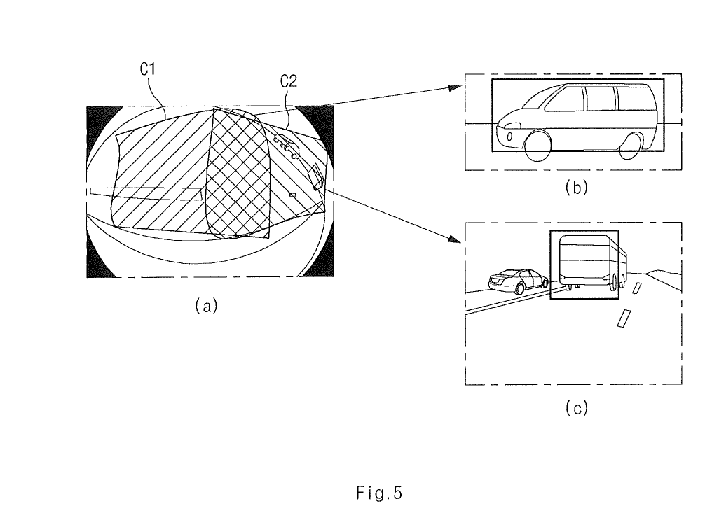

FIG. 5 is an exemplary view illustrating a feature extraction operation of an information providing apparatus according to the present disclosure. In particular, FIG. 5(a) illustrates a rear side area C2 illustrated in FIG. 3 and a side area C1 illustrated in FIG. 4 and view transformed images for images of the respective areas C1 and C2 are as illustrated in FIGS. 5(b) and 5(c).

The information providing apparatus may be configured to extract features of objects positioned in the side area and the rear side area from the view transformed images illustrated in FIGS. 5(b) and 5(c) and may detect a vehicle and the like from the extracted features.

An operation of the information providing apparatus having the above-described configuration according to the present disclosure will be described below.

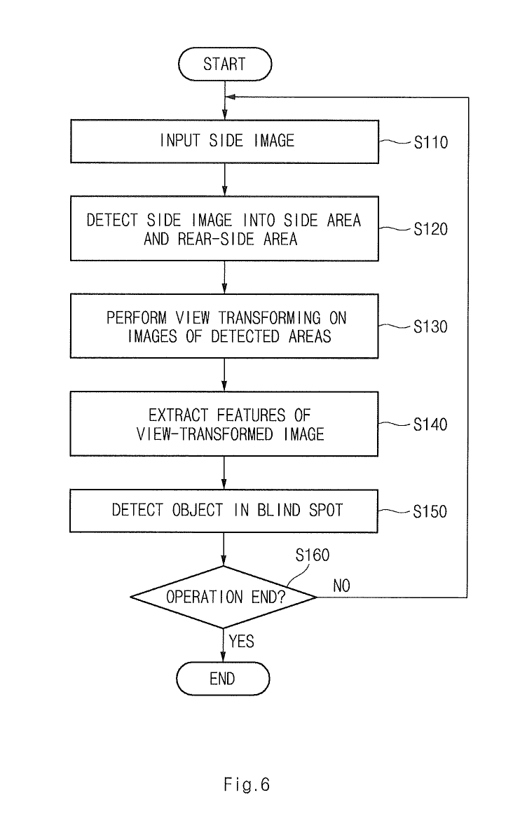

FIG. 6 is an exemplary flowchart illustrating a method of providing information regarding a blind slot in a vehicle according to the present disclosure. Referring to FIG. 6, when an image of a side imaging device is received from an imaging device disposed in a side of the vehicle (S100), an apparatus (e.g., a controller) may be configured to detect a side area and a rear side area designated in the input image of a side imaging device (S120).

The controller may be configured to view transform images of the respective areas detected in step S120 (S130). Detailed operation for the view transformation operation performed in step S130 has been described with reference FIGS. 3 and 4.

The controller may further be configured to extract features of the respective view transformed images generated in step S130, in other words, the features from the view transformed image for the side area and the features from the view transformed image for the rear side area (S140). Furthermore, the controller may be configured to detect an object of a blind spot from the features extracted in step S140, such as, a vehicle or a person (S150).

In particular, in step S150, features for a vehicle may be previously defined and the controller may be configured to compare the features extracted in step S140 and the predefined features of a vehicle and detect a vehicle in a blind spot when the extracted features are substantially similar to the predefined features.

As described above, the information providing apparatus may be configured to detect objects in a side area and a rear side area of the vehicle, in particular, in a blind spot using steps S100 to step S150 and the process from steps S100 to step S150 may be repeatedly performed until a separate operation end command is received. When the operation end command for the information providing operation is received (S160), the controller may be configured to complete the related operation.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the accompanying claims and their equivalents.

What is claimed is:

1. An apparatus for providing information of a blind spot in a vehicle, the apparatus comprising:
a view transforming area detector configured to detect a predefined side area and a rear side area from a captured image input from a side imaging device, wherein the imaging device is configured to capture the image including the blind spot of the vehicle; and
a view transformer configured to view transform an image of the side area and an image of the rear side area based on a pre-set view transformation parameter and generate view transformed images corresponding to the images of the side area and the rear side area.

2. The apparatus of claim 1, wherein the view transformer includes a table in which a value of the view transformation parameter has been previously defined and is further configured to perform view transformation on the image of the side area and the image of the rear side area based on the value of the view transformation parameter defined in the table.

3. The apparatus of claim 1, wherein the side imaging device is a wide angle camera and the view transformer is configured to view transforms the captured image having a wide angle into an image having a narrower angle than a capturing angle.

4. The apparatus of claim 3, wherein the view transformer includes:
a first view transforming unit configured to view transform the image of the side area according to a first view transformation parameter to generate a first view transformed image; and
a second view inverting unit configured to view transform the image of the rear side area according to a second view transformation parameter to generate a second view transformed image.

5. The apparatus of claim 1, further comprising:
a feature extractor configured to extract features from the view transformed images; and
a detector configured to detect an object in the blind spot based on the features extracted from the view transformed images.

6. The apparatus of claim 5, wherein the detector is further configured to:
compare the features extracted from the view transformed images with pre-stored features of a vehicle; and
detect a vehicle in the blind spot according to a comparison result.

7. The apparatus of claim 6, wherein the features of the vehicle includes at least one selected from the group consisting of: features for shapes of a front, a side, a bottom, and a wheel of the vehicle and motion information of the vehicle

8. A method for providing information of a blind spot in a vehicle, the method comprising:
detecting, by a controller, a predefined side area and a rear side area from an captured image captured in a side imaging device configured to capture the image including the blind spot of the vehicle;
view transforming, by the controller, an image of the side area and an image of the rear side area based on a pre-set view transformation parameter; and
generating, by the controller, view transformed images corresponding to the images of the side area and the rear side area.

9. The method of claim 8, wherein the generating view transformed images includes view transforming, by the controller, the images of the side area and the rear side area based on a value of the view transformation parameter defined in a table in which the value of the view transformation parameter has been previously defined.

10. The method of claim 8, wherein the side imaging device is a wide angle camera and the view transforming includes viewing transforming, by the controller, the capture image having a wide angle into a narrow angle image.

11. The method of claim 10, wherein the generating view transformed images includes:
first view transforming, by the controller, the image of the side area using a first view transformation parameter to generate a first view transformed image; and
second view transforming, by the controller, the image of the rear side area using a second view transformation parameter to generate a second view transformed image.

12. The method of claim 8, further comprising:
extracting, by the controller, features from the view transformed images; and
detecting, by the controller, an object in the blind spot based on the features extracted from the view transformed images.

13. The method of claim 12, wherein the detecting an object of the blind spot includes:
comparing, by the controller, the features extracted from the view transformed images and pre-set features of a vehicle; and
detecting, by the controller, a vehicle in the blind spot according to a comparison result.

14. The method of claim 13, wherein the features of the vehicle includes at least one selected from the group consisting of: features for shapes of a front, a side, a bottom and a wheel of the vehicle and motion information of the vehicle.

15. A non-transitory computer readable medium containing program instructions executed by a processor or controller, the computer readable medium comprising:
program instructions that detect a predefined side area and a rear side area from an captured image captured in a side imaging device configured to capture the image including the blind spot of the vehicle;
program instructions that view transform an image of the side area and an image of the rear side area based on a pre-set view transformation parameter; and
program instructions that generate view transformed images corresponding to the images of the side area and the rear side area.

16. The non-transitory computer readable medium of claim 15, further comprising:
program instructions that first view transform the image of the side area using a first view transformation parameter to generate a first view transformed image; and
program instructions that second view transform the image of the rear side area using a second view transformation parameter to generate a second view transformed image.

17. The non-transitory computer readable medium of claim 15, further comprising:
program instructions that extract features from the view transformed images; and
program instructions that detect an object in the blind spot based on the features extracted from the view transformed images.

18. The non-transitory computer readable medium of claim 15, further comprising:
program instructions that compare the features extracted from the view transformed images and pre-set features of a vehicle; and
program instructions that detect a vehicle in the blind spot according to a comparison result.
